(19) United States
(12) Patent Application Publication
(10) Pub. No.: US 2011/0252751 A1
(43) Pub. Date: Oct. 20, 2011

(54) HORSE HALTER APPARATUS

(76) Inventor: Frank Nin, Mission Viejo, CA (US)

(21) Appl. No.: 12/760,376

(22) Filed: Apr. 14, 2010

(51) Int. Cl. B68B 1/02

(52) U.S. Cl. 54/24

(57) ABSTRACT

A horse halter apparatus includes top nose portion with a curved rigid nose bar, a separate left chin portion with a first rigid chin bar, and a separate right chin portion with a second rigid chin bar. Soft, pliable covers enclose each rigid bar and hide the bars from view while protecting the horse's face from scratches or marks. A user holding a leash may apply pressure, via the rigid bars, in three different directions: downward, left and right. Each of the nose portion and chin portions may be adjustable in length. The rigid bars may be removable from the covers. The rigid bars may come in different configurations with varying profiles such as circular or rectangular, and may be formed with protuberances directed towards the horse's face.

### BACKGROUND OF THE INVENTION

1. Field of the Invention

The present invention relates generally to training apparatuses for horses.

2. Description of Prior Art and Related Information

One of the challenges in training horses is trying to get a horse to obey the leading of a person walking the horse. Such difficulty is compounded when the person is generally small and light. Conventional halters do not provide any practical usefulness in training as horses will simply snap their heads in response to any attempts to yank such halters.

### SUMMARY OF THE INVENTION

The present invention provides structures and methods which overcome the deficiencies in the prior art.

In one aspect, a horse halter apparatus is provided. The apparatus comprises an upper noseband portion, a left chin portion and a right chin portion. The noseband portion includes a curved rigid bar and a generally flexible noseband cover. The left chin portion includes a first rigid chin bar that is separate from the curved rigid bar and a generally flexible left chin cover. The right chin portion includes a second rigid chin bar that is separate from the curved rigid bar and the first chin bar.

The curved rigid bar is removable from the flexible noseband cover in one preferred embodiment. The first rigid chin bar is preferably from the left chin cover in one preferred embodiment. The second rigid chin bar is preferably removable from the right chin cover in one preferred embodiment. The curved rigid bar is preferably circular in cross-section. The first rigid chin bar is preferably circular in cross-section. The second rigid chin bar is preferably circular in cross-section. In another preferred embodiment, the curved rigid bar may be rectangular in cross-section while the first rigid chin bar and the second rigid chin bar may each be rectangular in cross-section. The left chin cover and the right chin cover may each be adjustable in length.

In another embodiment, the upper noseband portion comprises protrusions configured to apply pressure to a horse's nose. The first rigid chin bar may comprise a first protrusion configured to apply pressure to a horse's chin. The second rigid chin bar may comprise a second protrusion configured to apply pressure to the horse's chin.

In another aspect, a horse halter apparatus comprises an upper noseband portion including a curved rigid bar and a generally flexible noseband cover. The curved rigid bar is removable from the flexible noseband cover. A left chin portion includes a first rigid chin bar that is separate from the curved rigid bar and a generally flexible left chin cover. The first rigid chin bar is removable from the left chin cover. A right chin portion includes a second rigid chin bar that is separate from the curved rigid bar and the first chin bar. The second rigid chin bar is removable from the right chin cover.

The curved rigid bar may be circular or rectangular in cross-section. The first rigid chin bar may be circular or rectangular in cross-section. The second rigid chin bar may be circular or rectangular in cross-section. The left chin cover may be adjustable in length. The right chin cover may be adjustable in length.

The upper noseband portion may comprise protrusions configured to apply pressure to a horse's nose. The first rigid chin bar may comprise a first chin protrusion configured to apply pressure to a horse's chin. The second rigid chin bar may comprise a second chin protrusion configured to apply pressure to the horse's chin.

In a further aspect, a horse halter apparatus comprises an upper noseband portion including a curved rigid bar and a generally flexible noseband cover. A left chin portion includes a first rigid chin bar that is separate from the curved rigid bar and a generally flexible left chin cover. The left chin cover is adjustable in length. A right chin portion includes a second rigid chin bar that is separate from the curved rigid bar and the first chin bar. The right chin cover is adjustable in length.

The curved rigid bar may be circular or rectangular in cross-section. The first rigid chin bar may be circular or rectangular in cross-section. The second rigid chin bar may be circular or rectangular in cross-section. The upper noseband portion may comprise protrusions configured to apply pressure to a horse's nose. The first rigid chin bar may comprise a first chin protrusion configured to apply pressure to a horse's chin. The second rigid chin bar may comprise a second chin protrusion configured to apply pressure to the horse's chin.

In a further aspect, horse halter apparatus includes top nose portion with a curved rigid nose bar, a separate left chin portion with a first rigid chin bar, and a separate right chin portion with a second rigid chin bar. Soft, pliable covers enclose each rigid bar and hide the bars from view while protecting the horse's face from scratches or marks. A user holding a leash may apply pressure, via the rigid bars, in three different directions: downward, left and right. Each of the nose portion and chin portions may be adjustable in length. The rigid bars may be removable from the covers. The rigid bars may come in different configurations with varying profiles such as circular or rectangular, and may be formed with protuberances directed towards the horse's face.

In a further aspect, a method is provided for training a horse. The method comprises pulling downward on a halter to cause a first upper rigid member to apply pressure to a nose of the horse, pulling the halter towards the horse's left side to apply pressure to the horse's right chin with a second separate rigid member, and pulling the halter towards the horse's right side to apply pressure to the horse's right chin with a third separate rigid member.

The method further comprises enclosing each of the first, second and third rigid members with a soft material which does not scratch or mark the horse's face. The method further comprises removing each of the first, second and third rigid members from the corresponding soft material. The method further comprises enclosing the second rigid member with a first chin cover, adjusting a length of the first chin cover, enclosing the third rigid member with a third chin cover, and adjusting a length of the third chin cover.

The invention, now having been briefly summarized, may be better appreciated by the following detailed description.

### BRIEF DESCRIPTION OF THE DRAWINGS

FIG. 1 is a perspective view of the first preferred embodiment on a horse halter apparatus;

FIG. 2 is cross-sectional view of the first preferred embodiment of a horse halter apparatus;

FIG. 3 is a perspective view of a second preferred embodiment of the horse halter apparatus;

FIG. 4 is perspective view of a third preferred embodiment of a horse halter apparatus;

FIG. 5 is perspective view of a fourth preferred embodiment of a horse halter apparatus;

FIG. 6 is a cross-sectional view of a fifth preferred embodiment of a horse halter apparatus; and

FIG. 7 is a diagram of a preferred method of training a horse.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

Throughout the specification, positional terms such as front, rear or back, left and right refer to the embodiments from the perspective of the horse.

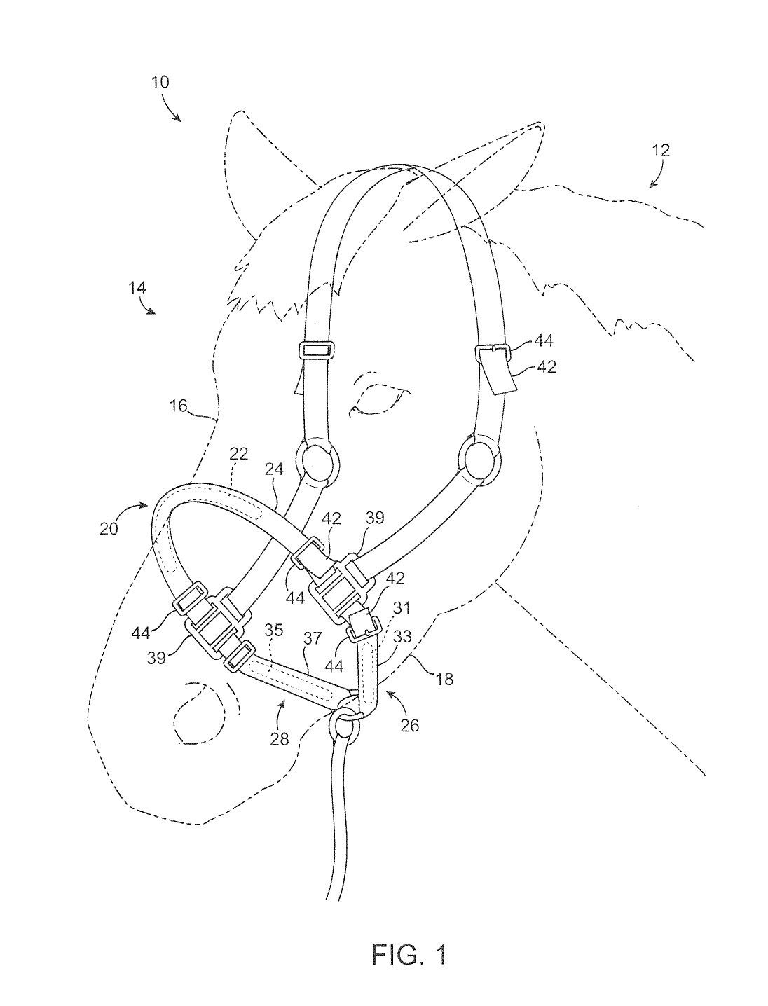

FIG. 1 is a perspective view a first preferred embodiment of a horse halter apparatus 10 used on a horse 12, particularly in connection with the horse's face 14, including its nose 16 and chin 18. The apparatus 10 is particularly configured for training the horse 12 by one who is dismounted and holding the apparatus 10 from underneath.

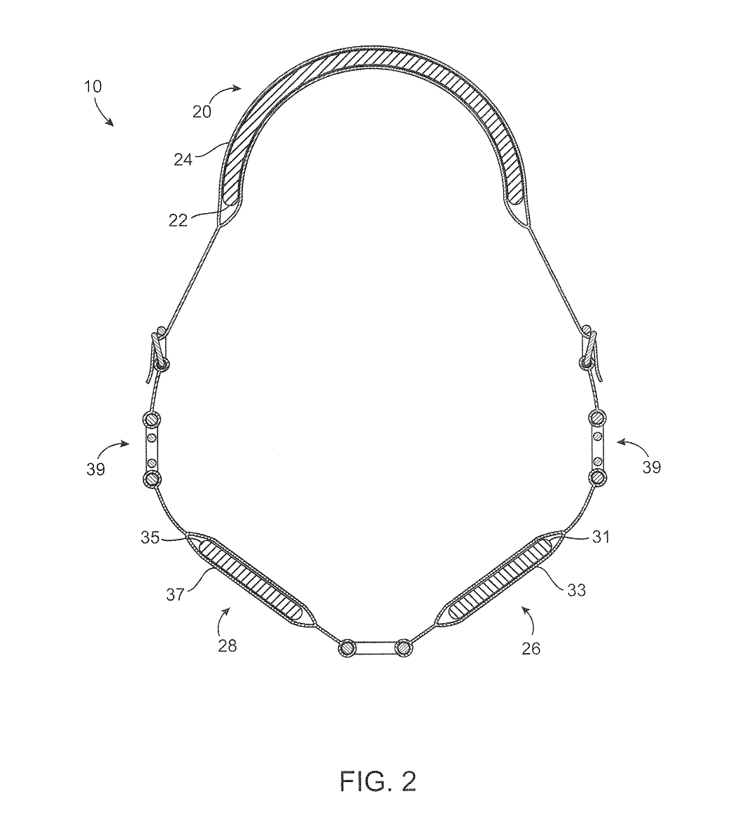

In FIGS. 1 and 2, the apparatus 10 comprises an upper noseband portion 20 including a curved rigid nose bar 22 housed within a generally soft, pliable nose cover 24. The curvature of the upper nose bar 22 is shaped to conform to the top of the horse's nose 16. A separate left chin portion 26 and a separate right chin portion 28 are coupled to each other and are disposed along the left and right chin portions of the horse, respectively. The left chin portion 26 includes a substantially straight rigid bar 31 enclosed within a soft, pliable cover 33. The right chin portion 28 includes a substantially straight rigid bar 35 also enclosed within a soft pliable cover 37. In the preferred embodiment, each rigid chin bar 31, 35 has a length in the preferred range of 3 to 8 inches. In the first preferred embodiment, each rigid chin bar 31, 35 is cylindrical and thus configured with a circular cross-sectional profile.

As examples and not by way of limitation, each of the rigid bars 22, 31, 35 may be composed of metal, hard plastic, wood, glass, and other such generally rigid materials. In the preferred embodiment, the rigid bars 22, 31, 35 each comprise metal. The soft, pliable covers

The noseband portion 20 is coupled to separate left chin portion 26 and right chin portion 28 with fasteners 39. The left chin portion 26 is also coupled to the right chin portion 28 with a fastener. Accordingly, thus the three facial portions 20, 26, 28 are individually separate from each other, while being coupled to each other fasteners 39 so as to fit around a horse's face 14. As will be described later, this enables the user to apply each portion 20, 26, 28 to the horse's face as desired.

In FIG. 1, the length of each facial portion 20, 26, 28 is preferably adjustable. In particular, each flexible outer cover 24, 33, 37 comprises straps 42 at opposite outer ends which can be coupled or looped through a buckle or clasp 44 so as to adjust the overall length of each facial portion 20, 26, 28. A leash 46 may be coupled to the connector 39 between the two chin portions 26, 28.

Referring to FIG. 1, it will be appreciated that the halter apparatus 10 enables a person to separately apply three different pressure points to the horse's face 14. In particular, a person may pull downwardly on the leash 46 to cause the rigid nose bar 22 to apply downward pressure on the horse's nose. One can also pull the leash 46 to the left of the horse 12 so as to cause the right chin bar 35 to apply pressure to the horse's right chin, or pull the leash 46 to the right of the horse 12 so as to cause the left chin bar 33 to apply pressure to the horse's left chin.

By making each rigid bar 22, 31, 35 separate, the apparatus 10 facilitates the three directional ways of applying rigid pressure to the horse's face.

Furthermore, the enclosing each rigid bar 22, 31, 35 in a separate flexible cover 24, 33, 37, respectively, provides for adjustability in the overall size of the halter apparatus to accommodate each individual horses' face. The flexible, soft material of each cover not only hides the rigid bars from view, but also protects the horse's face 14 by preventing any marks that might otherwise result from direct contact with rigid bars, such as metal, for example.

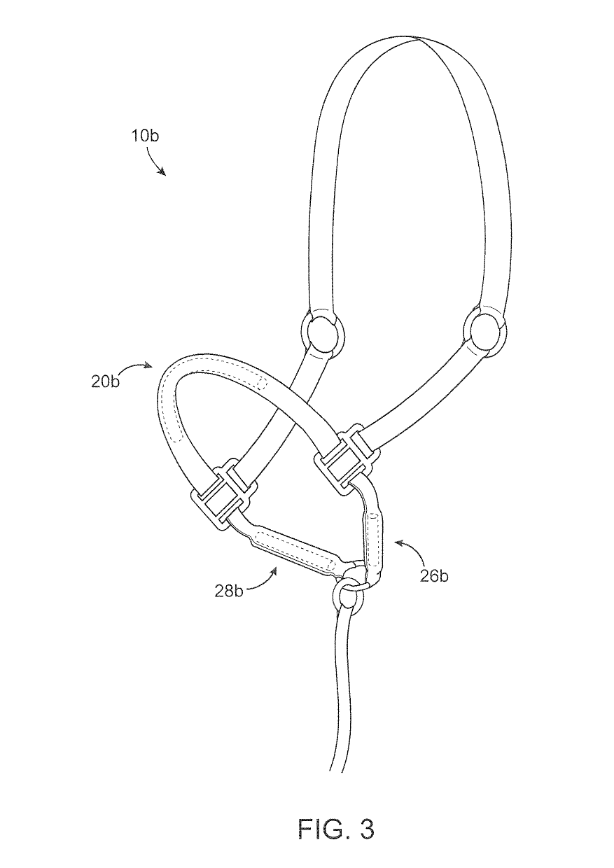

FIG. 3 is a perspective view of a second preferred embodiment of a horse halter apparatus 10b where elements of similar structure are designated by the same reference numerals followed by the lower case “b.” In FIG. 2, each of the facial portions 20b, 26b, 28b may be configured with a fixed length. The halter apparatus 10b may be preconfigured at the manufacturing stage with a predetermined lengths for each of the facial portions 20b, 26b, 28b so as to form an assembled apparatus 10b of varying sizes, e.g., small, medium, large, etc.

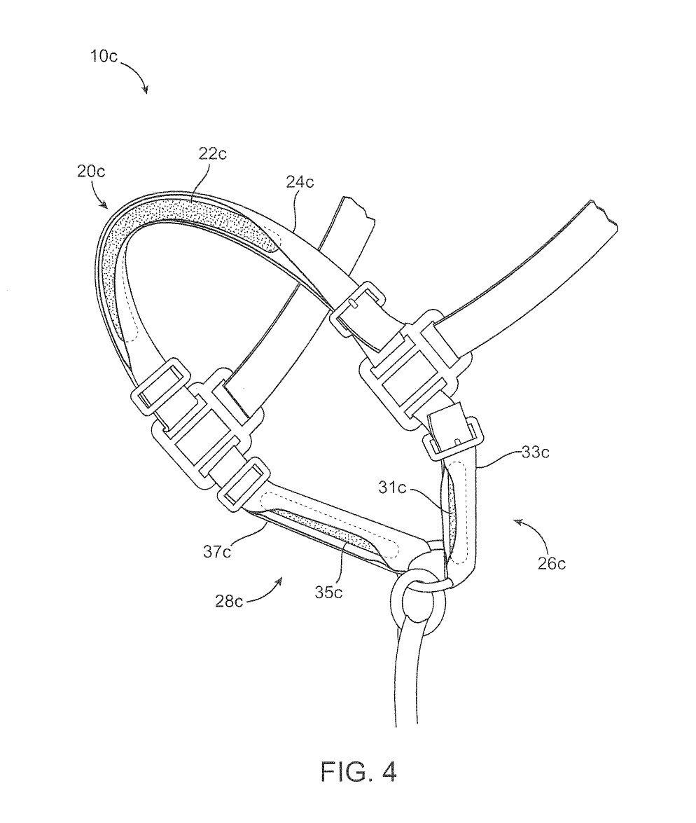

FIG. 4 is a perspective view of a third preferred embodiment of a horse halter apparatus 10c where elements of similar structure are designated by the same reference numerals followed by the lower case “c.” In FIG. 4, each facial portion 20c, 26c, 28c comprises a removable rigid bar 22c, 31c, 35c, respectively. In particular, each outer cover 24c, 33c, 37c can be formed with an opening or slot for removing the rigid bar therein. Such a removable feature may be desired if, for example, rigid bars of differing sizes or configurations are desired to be used on a particular horse.

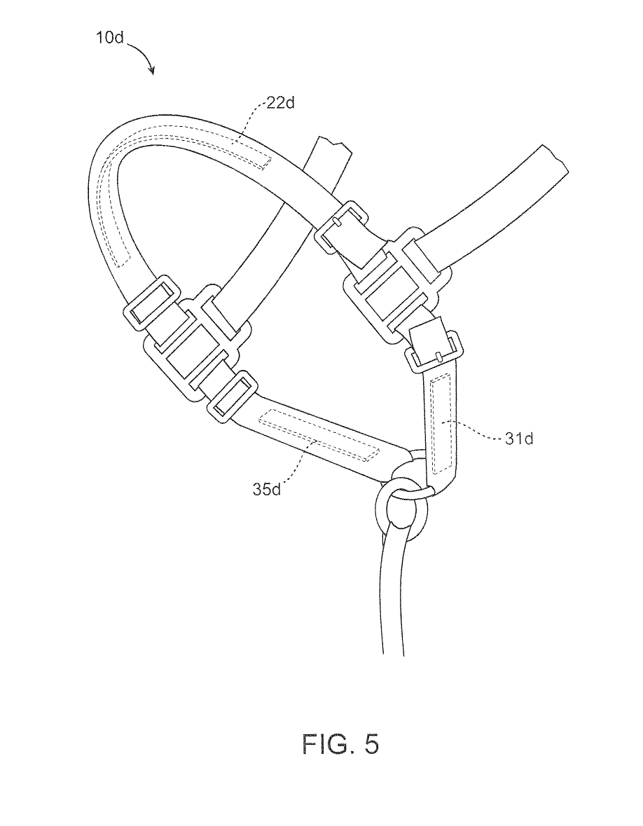

FIG. 5 is a perspective view of a fourth preferred embodiment of a horse halter apparatus 10d where elements of similar structure are designated by the same reference numerals followed by the lower case “d.” In FIG. 5, the rigid nose bar 22d comprises a curved plate having a rectangular profile, or cross-section. Both rigid chin bars 31d, 35d also comprise plates.

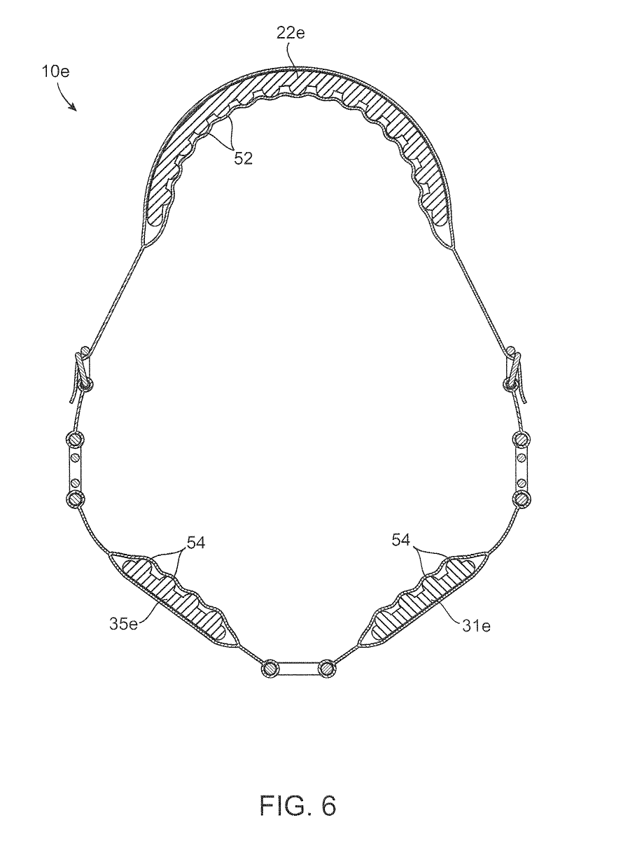

FIG. 6 is a perspective view of a fifth preferred embodiment of a horse halter apparatus 10e where elements of similar structure are designated by the same reference numerals followed by the lower case “e.” In FIG. 6, the rigid nose bar 22e comprises a series of protrusions 52 directed at the horse's nose. Both rigid chin bars 31e, 35e comprise a series of protrusions 54 directed at the horse's chin.

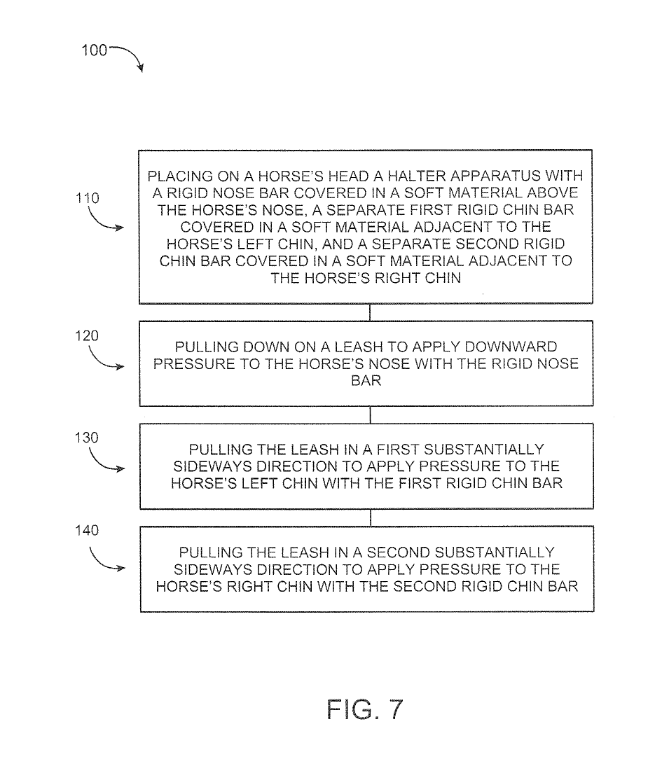

FIG. 7 is a diagram illustrating a preferred method 100 of training a horse. The method 100 comprises the step 110 of placing on a horse's head a halter apparatus with a rigid nose bar covered in a soft material above the horse's nose, a separate first rigid chin bar covered in a soft material adjacent to the horse's left chin, and a separate second rigid chin bar covered in a soft material adjacent to the horse's right chin. Step 120 comprises pulling down on a leash to apply downward pressure to the horse's nose with the rigid nose bar. Step 12o comprises applying pressure to the horse's nose without applying pressure to the horse' chin. Step 130 comprises pulling the leash in a first substantially sideways direction to apply pressure to the horse's left chin with the first rigid chin bar. Step 130 comprises applying pressure to the horse' left chin without applying pressure to any other portion of the horse' face. Step 140 comprises pulling the leash in a second substantially sideways direction to apply pressure to the horse's right chin with the second rigid chin bar. Step 140 comprises applying pressure to the horse' right chin without applying pressure to any other portion of the horse' face.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A horse halter apparatus, comprising:
an upper noseband portion including a curved rigid bar and a generally flexible noseband cover;
a left chin portion including a first rigid chin bar that is separate from the curved rigid bar and a generally flexible left chin cover; and
a right chin portion including a second rigid chin bar that is separate from the curved rigid bar and the first chin bar.

2. The apparatus of claim 1, wherein:
the curved rigid bar is removable from the flexible noseband cover;
the first rigid chin bar is removable from the left chin cover; and
the second rigid chin bar is removable from the right chin cover.

3. The apparatus of claim 1, wherein:
the curved rigid bar is circular in cross-section;
the first rigid chin bar is circular in cross-section; and
the second rigid chin bar is circular in cross-section.

4. The apparatus of claim 1, wherein:
the curved rigid bar is rectangular in cross-section;
the first rigid chin bar is rectangular in cross-section; and
the second rigid chin bar is rectangular in cross-section

5. The apparatus of claim 1, wherein:
the left chin cover is adjustable in length; and
the right chin cover is adjustable in length.

6. The apparatus of claim 1, wherein:
the upper noseband portion comprises protrusions configured to apply pressure to a horse's nose.

7. The apparatus of claim 1, wherein:
the first rigid chin bar comprises a first protrusion configured to apply pressure to a horse's chin; and
the second rigid chin bar comprises a second protrusion configured to apply pressure to the horse's chin.

8. A horse halter apparatus, comprising:
an upper noseband portion including a curved rigid bar and a generally flexible noseband cover, the curved rigid bar is removable from the flexible noseband cover;
a left chin portion including a first rigid chin bar that is separate from the curved rigid bar and a generally flexible left chin cover, the first rigid chin bar is removable from the left chin cover; and
a right chin portion including a second rigid chin bar that is separate from the curved rigid bar and the first chin bar, the second rigid chin bar is removable from the right chin cover.

9. The apparatus of claim 8, wherein:
the curved rigid bar is circular in cross-section;
the first rigid chin bar is circular in cross-section; and
the second rigid chin bar is circular in cross-section.

10. The apparatus of claim 8, wherein:
the curved rigid bar is rectangular in cross-section;
the first rigid chin bar is rectangular in cross-section; and
the second rigid chin bar is rectangular in cross-section

11. The apparatus of claim 8, wherein:
the left chin cover is adjustable in length; and
the right chin cover is adjustable in length.

12. The apparatus of claim 8, wherein:
the upper noseband portion comprises protrusions configured to apply pressure to a horse's nose;
the first rigid chin bar comprises a first chin protrusion configured to apply pressure to a horse's chin; and
the second rigid chin bar comprises a second chin protrusion configured to apply pressure to the horse's chin.

13. A horse halter apparatus, comprising:
an upper noseband portion including a curved rigid bar and a generally flexible noseband cover;
a left chin portion including a first rigid chin bar that is separate from the curved rigid bar and a generally flexible left chin cover, the left chin cover being adjustable in length; and
a right chin portion including a second rigid chin bar that is separate from the curved rigid bar and the first chin bar, the right chin cover being adjustable in length.

14. The apparatus of claim 13, wherein:
the curved rigid bar is circular in cross-section;
the first rigid chin bar is circular in cross-section; and
the second rigid chin bar is circular in cross-section.

15. The apparatus of claim 13, wherein:
the curved rigid bar is rectangular in cross-section;
the first rigid chin bar is rectangular in cross-section; and
the second rigid chin bar is rectangular in cross-section

16. The apparatus of claim 13, wherein:
the upper noseband portion comprises protrusions configured to apply pressure to a horse's nose;
the first rigid chin bar comprises a first chin protrusion configured to apply pressure to a horse's chin; and
the second rigid chin bar comprises a second chin protrusion configured to apply pressure to the horse's chin.

17. A method for training a horse, comprising:
pulling downward on a halter to cause a first upper rigid member to apply pressure to a nose of the horse;
pulling the halter towards the horse's left side to apply pressure to the horse's right chin with a second separate rigid member; and
pulling the halter towards the horse's right side to apply pressure to the horse's right chin with a third separate rigid member.

18. The method of claim 17, further comprising:
enclosing each of the first, second and third rigid members with a soft material which does not scratch or mark the horse's face.

19. The method of claim 17, further comprising removing each of the first, second and third rigid members from the corresponding soft material.

20. The method of claim 17, further comprising:
enclosing the second rigid member with a first chin cover;
adjusting a length of the first chin cover;
enclosing the third rigid member with a third chin cover; and
adjusting a length of the third chin cover.
